(19) United States
(12) Patent Application Publication
(10) Pub. No.: US 2025/0007743 A1
(43) Pub. Date: Jan. 2, 2025

(54) ELECTROMECHANICAL SENSING SYSTEM

(71) Applicants: Tony SPATH, Greenville, SC (US); Shadi ABUGHAZALEH, Guilford, CT (US); Timothy WILLIS, Clemson, SC (US); Christopher BAILEY, Greenville, SC (US); Hubbell Incorporated, Shelton, CT (US)

(72) Inventors: Tony Spath, Greenville, SC (US); Shadi AbuGhazaleh, Guilford, CT (US); Timothy Willis, Clemson, SC (US); Christopher Bailey, Greenville, SC (US)

(73) Assignee: Hubbell Incorporated, Shelton, CT (US)

(21) Appl. No.: 18/710,870

(22) PCT Filed: Nov. 17, 2022
(86) PCT No.: PCT/US2022/080060

§ 371 Date: May 16, 2024

Related U.S. Application Data
(60) Provisional application No. 63/281,387, filed on Nov. 19, 2021.

(51) Int. Cl. H04L 12/18; H04W 84/18

(52) U.S. Cl. CPC H04L 12/1868; H04L 12/189; H04W 84/18

(57) ABSTRACT

A sensing device having an input-output module configured to interface with an external device and a communication module. The sensing device further including one or more electronic processors configured to receive parameters associated with the external device via the input-output module and package the received data into a message. The electronic processors are also configured to determine whether the message is able to be transmitted and transmit the message in response to determining the message can be transmitted.

### CROSS-REFERENCE TO RELATED APPLICATIONS

This application priority to, and the benefit of, U.S. Provisional Patent Application No. 63/281,387, filed Nov. 19, 2021, the entire contents of which are hereby incorporated by reference herein in their entirety.

### FIELD

The embodiments disclosed herein relate to non-centralized device sensing systems and methods.

### BACKGROUND

Electromechanical devices, such as those in industrial and commercial applications, control various operations and processes within an environment. While some of these devices are networked into a central system, others, either due to location or importance, may not be coupled to an existing network. Further, the data associated with these devices may not be sufficiently important to justify the expense and bandwidth required to add them to an existing network. Thus, an ability to create an ad-hoc or limited network between various devices and data collection devices provides an advantageous solution.

### SUMMARY

In one embodiment, a sensing device is described that includes an input-output module configured to interface with an external device, a communication module, and one or more electronic processors. The one or more electronic processors are configured to receive one or more parameters associated with the external device via the input-output module and package the received data. The electronic processors are further configured to determine whether a broadcast interval has expired and broadcast the packaged data in response to determining that the broadcast interval has expired.

In one aspect, packaging the data includes embedding the data into a Wi-Fi SSID packet.

In another aspect, broadcasting the data includes transmitting the data using one of a Wi-Fi protocol and a Bluetooth protocol.

In another aspect, the external device is an electromechanical device.

In another aspect, the broadcast interval is one second.

In another embodiment, a sensing device is described having an input-output module configured to interface with an external device, a communication module, and one or more electronic processors. The electronic processors are configured to receive one or more parameters associated with the external device via the input-output module and package the received data. The electronic processors are further configured to establish a communication link with one or more external devices and transmit the packaged data in response to establishing the communication link.

In one aspect, packaging the received data includes packaging the data into a Bluetooth message.

In another aspect, transmitting the packaged data includes transmitting the packaged data using one or more of a Wi-Fi protocol, a Bluetooth protocol, and a Zigbee protocol.

In another aspect, the external device is an electromechanical device.

In another aspect, the input-output interface is a general-purpose input-output interface.

In another aspect, the sensing device further includes one or more sensors configured to sense supplemental parameters associated with the external device.

In another embodiment, a method is described that includes sensing one or more parameters of an electromechanical device, packaging the sensed parameters into a message, and determining whether the message can be transmitted. The method further includes transmitting the message to one or more external devices based on determining that the message can be transmitted.

In one aspect, the message is determined to be able to be transmitted based on determining that a broadcast interval time period has expired.

In another aspect, the broadcast interval time period is one second.

In another aspect, the message is determined to be able to be transmitted based on determining that a communication link with the one or more external devices has been established.

In another aspect, the method further includes receiving the message at a first external device of the one or more external devices, extracting data from the message, and transmitting the extracted data to a central controller.

In another aspect, the first external device is a smartphone.

In another aspect, the message is transmitted using one or more of a Wi-Fi communication protocol and a Bluetooth communication protocol.

In another aspect, packaging the data includes embedding the data into a Wi-Fi SSID packet.

In another aspect, the method further includes receiving one or more parameters from the electromechanical device via an input-output interface of the electromechanical device, wherein the receiving parameters are separate from the sensed parameters.

Other aspects of the technology will become apparent by consideration of the detailed description and accompanying drawings.

### BRIEF DESCRIPTION OF THE DRAWINGS

FIG. 1 is a block diagram illustrating one exemplary embodiment of a non-centralized communication system.

FIG. 2 is a block diagram illustrating one exemplary embodiment of a sensor module.

FIG. 3 is a block diagram illustrating one exemplary embodiment of a data collection device.

FIG. 4 is a flowchart illustrating one exemplary embodiment of a data collection and broadcasting process.

FIG. 5 is a flowchart illustrating one exemplary embodiment of a data collection and transmission process.

FIG. 6 is a flowchart illustrating one exemplary embodiment of a data processing process at a data collection device.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

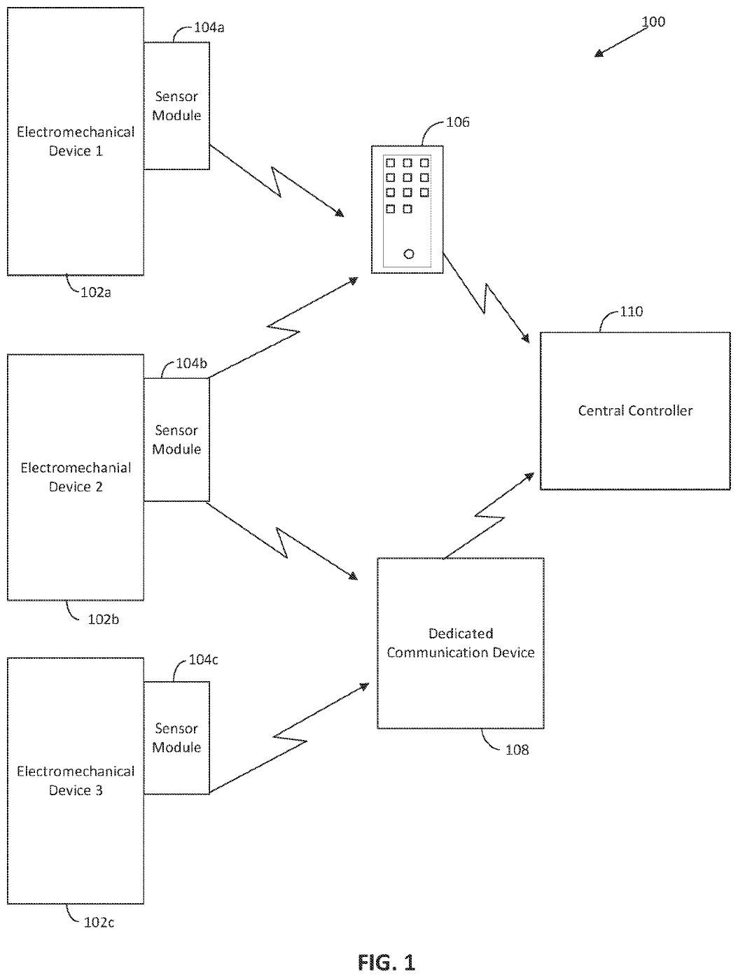

FIG. 1 illustrates an example non-centralized communication system 100, according to some embodiments. The system 100 includes a number of electromechanical devices 102a-c. The electromechanical devices 102a-c may be various devices, such as lighting devices, electrical outlets, appliances, surveillance devices, parking management devices, tools, power equipment, shopping carts, fleet vehicles, security device, etc. Example appliances may include garbage receptacles, dishwashers, stoves/ranges/ovens, washer/dryers, etc. Surveillance devices may include devices such as cameras, microphones, access limiting devices (e.g., smart locks, keypads, RFID readers), etc. Power equipment may include various machines used in residential, commercial or industrial applications. In some examples, the system 100 may be used with a variety of electromechanical devices 102a-c. Furthermore, while the system 100 shows only three electromechanical devices 102a-c, it is understood that the system 100 may include more than three electromechanical devices 102a-c or less than three electromechanical devices 102a-c.

Each electromechanical device 102a-c may include one or more sensor modules 104a-c. Each sensor module 104a-c may be configured to sense or receive one or more parameters or other data associated with the coupled electromechanical device 102a-c. In some embodiments, the sensor modules 104a-c are coupled to an existing electromechanical device 102a-c. In other embodiments, the sensor modules 104a-c are integrated into the electromechanical devices 102a-c during installation or manufacturing. As will be described in more detail below, the sensor modules 104a-c may be configured to sense various parameters associated with the electromechanical devices 102a-c, such as location, temperature, radiation levels, proximity to other devices, pressures, position (e.g. accelerometer data), photoelectric (e.g. light levels), particle intensity, motion, metal detection, level, leak, humidity, gas and/or chemical sensing, force, flow, flaw, flame, voltage, current, contact/non-contact, as well as other parameters as required for a given application. In some embodiments, the sensor modules 104a-c may include one or more sensors for detecting one or more parameters, such as those described above. In other embodiments, the sensor modules 104a-c may communicate with one or more sensors or other devices associated with the one or more sensors. In further examples, the sensor modules 104a-c may be configured to receive power via the electromechanical devices 102a-c, such as via a hardwired connection. However, in other examples, the sensor modules 104a-c may include a power source, such as a battery or other external power source. In still further examples, the sensor modules 104a-c may be configured to both receive power from an associated electromechanical device 102a-c and/or an internal or external power source, depending on a given application.

The system 100 further includes data collections devices such as a mobile device 106 in communication with one or more of the sensor modules 104a-c. In one embodiment, the mobile device 106 is a smartphone device, such as an iPhone©, Windows© Phone, Android© Phone, etc. However, other smartphone types are also contemplated. The mobile device 106 may also be a computing device, such as a tablet computer (e.g., iPad©, Android© tablet, Microsoft Surface*, etc.). The mobile device 106 may include one or more software programs or applications that are configured to facilitate communication with the one or more sensor modules 104a-c, as well as processing of received data, as will be described in more detail below. In some examples, the mobile device 106 is configured to communicate with the one or more sensor modules 104a-c using one or more wireless communication protocols, such as, Bluetooth, Bluetooth Low Energy (“BLE”), Cellular (e.g. 3G, 4G, 5G, LTE, CDMA, TDMA, etc.), RF, Wi-Fi, LoRa, LoRaWAN, Z-wave, Thread, Matter, and/or any other applicable wireless communication protocol as described in more detail below. In some examples, the mobile device 106 may communicate using a proprietary communication protocol.

The system 100 may include additional data collection devices such as a dedicated communication device 108 for communicating with the one or more sensor modules 104a-c. In one embodiment, the dedicated communication device 108 may include one or more components to allow for the dedicated communication device 108 to communicate with, and process data received from, the one or more sensor modules 104a-c, similar to the mobile device 106, described above. For example, the dedicated communication device 108 may include one or more software programs or applications configured to facilitate communication with the one or more sensor modules 104a-c, as well as processing of received data, as will be described in more detail below. In some examples, the dedicated communication device 108 is configured to communicate with the one or more sensor modules 104a-c using one or more wireless communication protocols, such as, Bluetooth, Bluetooth Low Energy (“BLE”), Cellular (e.g. 3G, 4G, 5G, LTE, CDMA, TDMA, etc.), RF, Wi-Fi, LoRa, LoRaWAN, Z-wave, Thread, Matter, and/or any other applicable wireless communication protocol as described in more detail below. In some examples, the dedication communication device 108 may communicate using a proprietary communication protocol.

While only two data collection devices, the mobile device 106 and the dedicated communication device 108, are shown in the system 100, it is contemplated that the system 100 may include multiple data collection devices, as well as multiple electromechanical devices and associated sensor modules. For example, various employees/vendors/contractors, etc. may carry a mobile device, such as mobile device 106, configured to function as a data collection device, thereby placing multiple data collection devices within a given environment. The more data collection devices present, the higher the likelihood that one or more of the data collection devices will be within a communication range of one or more of the sensor modules, such as sensor modules 104a-c.

For example, as shown in FIG. 1, the sensor module 104a may only be within communication range of mobile device 106. However, the sensor module 104b may be within communication range of both the mobile device 106 and the dedicated communication device 108. Finally, the sensor module 104c may only be within range of dedicated communication device 108. Accordingly, by scaling up the number of data collection devices within a system, the chances of one or more of the sensor modules 104a-c (or others in the case of a larger system) being within a communication range of one or more data collection increases. Further, as the data collection devices are contemplated to be mobile (i.e., carried by a user), the data collection devices may be within a communication range of different sensor modules 104a-c as the user moves about an environment. Thus, again, by increasing the number of data collection devices within an environment, the number of sensor modules coming within communication range of the data collection devices increases, thereby decreasing the time between when data may be collected from various sensor modules, such as described in more detail below. The communication range of the sensor modules 104a-c may vary based on the type of communication protocol, installation area, obstructions, etc.

The mobile device 106 and/or dedicated communication device 108 may further be configured to communicate with a central controller 110. The central controller 110 may be a dedicated server system, a cloud-based controller, etc. In one embodiment, the central controller 110 may communicate with one or more cloud-based platforms or internet observers. In one embodiment, the internet observer may be a third-party server configured to receive data or messages from devices such as the mobile device 106 and/or dedicated communication device 108, and process the data to provide information to an entity responsible for the one or more electromechanical devices 102a-c. In some examples, the central controller 110 may receive data from devices such as the mobile device 106 and/or dedicated communication device 108, and process the data to provide information to an entity responsible for the one or more electromechanical devices 102a-c.

For example, the central controller 110 may receive data from the mobile device 106 and/or dedicated communication device 108 and perform one or more actions, such as scheduling preventative maintenance, generating a repair work order, etc. In other examples, the central controller 110 may store the received data in a local or remote (e.g., cloud-based) server or database for later processing. The central controller 110 may further be configured to, in response to processing the received data, initiate an action such as sending an e-mail, text message, and/or other notification to a user. The central controller 110 may further be configured to update or schedule maintenance and/or service events.

As will be described in more detail below, the sensor modules 104a-c may be configured to create one or more ad-hoc networks using communication protocols, such as those described above. For example, the sensor modules 104a-c may broadcast data at certain predetermined intervals, which may be received by devices such as the mobile device 106 and/or dedicated communication device 108 in range of the broadcasted communication. In some examples, the broadcasted data may include one or more parameters associated with the electromechanical devices 102a-c, such as those sensed via the sensor modules 104a-c. By broadcasting data to one or more mobile devices 106 and/or dedicated communication devices 108, an ad-hoc network is generated that allows for data associated with the one or more electromechanical devices 102a-c to be collected without requiring a dedicated network to be created, or piggybacking onto an existing network, such as those in a facility wherein the electromechanical devices 102a-c are located.

In other examples, the ad-hoc network may be created by each sensor module 104a-c establishing a communication link with one or more data collection devices. For example, the sensor modules 104a-c may attempt to establish a communication link with any data collection device that comes within a communication range of the sensor modules 104a-c. For example, the sensor modules 104a-c may constantly broadcast their presence via a communication protocol (e.g., Bluetooth, Wi-Fi, etc.) and wait for a response from a data collection device to establish a communication link. In other examples, the sensor modules 104a-c may listen for messages broadcast by nearby data collection devices and respond based on the received broadcast.

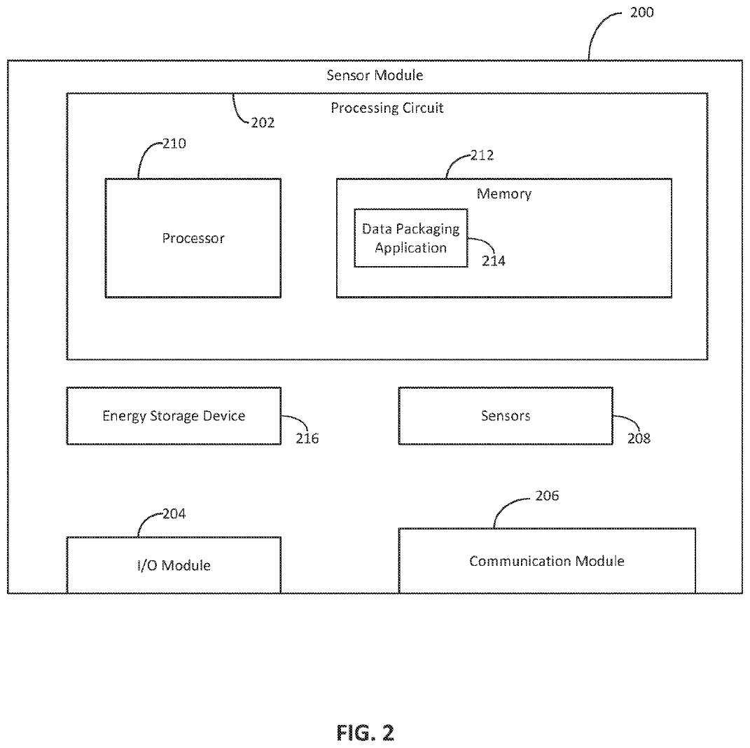

Turning now to FIG. 2, a block diagram illustrating a sensor module 200 is shown, according to some embodiments. The sensor module 200 may be similar to the sensor modules 104a-c, described above. Similarly to above, the sensor module 200 is configured to interface with one or more electromechanical devices, such as electromechanical devices 102a-c described above, to monitor one or more parameters associated with the electromechanical device and communicate the data to one or more other devices, such as a mobile device 106 and/or a dedicated communication device 108, as described above.

As shown in FIG. 2, the sensor module 200 includes a processing circuit 202, an input/output (“I/O”) module 204, a communication module 206, and one or more sensors 208. The processing circuit 202 may include an electronic processor 210 and a memory 212. The processing circuit 202 may be communicably connected to one or more of the I/O modules 204, the communication module 206 and/or the sensors 208. The electronic processor 210 may be implemented as a programmable microprocessor, an application specific integrated circuit (ASIC), one or more field programmable gate arrays (FPGA), a group of processing components, or other suitable electronic processing components.

The memory 212 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory 212 may include database components, object code components, script components, or other types of code and information for supporting the various activities and information structure described in the present application. According to one example, the memory 212 is communicably connected to the electronic processor 210 via the processing circuit 202 and may include computer code for executing (for example, by the processing circuit 202 and/or the electronic processor 210) one or more processes described herein.

In one embodiment, the memory 212 may include one or more applications, programs, etc., such as a data packaging application 214. The data packaging application 214 may be configured to perform one or more functions or operations, such as collecting, packaging, and transmitting data associated with an electromechanical device coupled to the sensor module 200, as will be described in more detail below.

The I/O module 204 may be configured to interface directly with one or more devices, such as an electromechanical device, as described above. In one embodiment, the I/O module 204 may utilize general purpose I/O (GPIO) ports, analog inputs, digital inputs, etc. to interface with the one or more devices. In one embodiment, the I/O module 204 may be configured to interface with an electromechanical device, such as electromechanical devices 102a-c, such that various parameters associated with the electromechanical device can be provided to the sensor module 200. For example, an electromechanical device may have one or more internal sensors, such as temperature sensors, current sensors, voltage sensors, etc., which can be communicated to the sensor module 200 via the I/O module 204. Other data, such as operating time, determined faults, location information, etc. may also be provided to the sensor module 200 via the I/O module. In still further examples, the sensor module 200 may receive power from the electromechanical devices directly via the I/O module 204. In other embodiments, the I/O module 204 may be coupled to one or more energy harvesting devices, such as current transformers (“CT”), which can provide energy to the sensor module 200. In one embodiment, the energy received via the I/O module 204 may be stored in an energy storage device 216, such as a battery (e.g., lithium-ion), super-capacitor, etc.

The communication module 206 may be configured to provide communications between the sensor module 200 and one or more external devices, such as a mobile device 106 and/or a dedicated communication device 108, described above. The communication module 206 may use one or more wireless communication protocols to provide communication to/from the external devices. In one embodiment, the local communication module uses Wi-Fi to provide communication to/from the external devices. However, other wireless communication protocols, such as Bluetooth, Cellular (e.g., 3G, 4G, 5G, LTE, CDMA, TDMA, etc.), RF, Wi-Fi, LoRa, LoRaWAN, Z-wave, Thread, and/or any other applicable wireless communication protocol. As noted above, in some examples, the communication module 206 may use a proprietary communication protocol to facilitate communication to/from one or more external devices.

The sensor module 200 may include one or more sensors 208 configured to monitor one or more aspects of an associated electromechanical device. Sensors may include voltage sensors, current sensors, power sensors, motion sensors (e.g. inclinometers, accelerometers, etc.), light sensors (e.g. photovoltaic sensors), sound sensors, level sensors, flow sensors, pressure sensors, temperature sensors, moisture sensors, gas and chemical sensors, leak sensors, metal sensors, motion sensors, force sensors, flaw sensors, contact and non-contact sensors, and/or other sensors as required for a given application. The sensors 208 are generally sensors in addition to those present within the electromechanical devices. For example, where the electromechanical sensor is a light, such as a streetlight or industrial light, the sensors 208 may include an illumination sensor to determine when the light output by the light source is reduced. In other examples, such as where the electromechanical device is associated with a garbage receptacle, the sensors 208 may include level sensors to determine when the receptacle needs to be emptied (e.g., is past a predetermined threshold level). Other sensors may include gas, pressure, humidity and/or temperature sensors to determine an air quality associated with the garbage receptacle.

In other examples, the electromechanical device may be a surveillance camera. The associated sensor module 200 may sense particular noises (e.g., gunshots, thunder, conversations, etc.) via an audio sensor. Additional sensors, such as visual and/or environmental sensors may be used to detect specific environmental conditions, such as snow, rain, severe weather, etc. Other sensors may include location sensors configured to monitor the location and movement of certain object or devices, such as fleet vehicles, mobile factory equipment (e.g., tuggers, forklifts, etc.), shopping carts, personnel, etc. Additionally, some sensors may provide operating data associated with the above movable objects, such as operating time, speed, detected forces, etc. Other sensors may include occupancy detection sensors for counting persons, determining occupancy of a location, detected an undesired presence (e.g., trespassers), etc.

In still further examples, the sensor module 200 may be coupled to non-electromechanical devices, such as dumpsters or garbage receptacles, tanks, etc. For example, the sensor module 200 may include one or more level sensors for determining a fill level of a tank, dumpster, and/or other storage device. Other examples may include street light sensing, sensing of packages within a mailbox or other receptable, and the like.

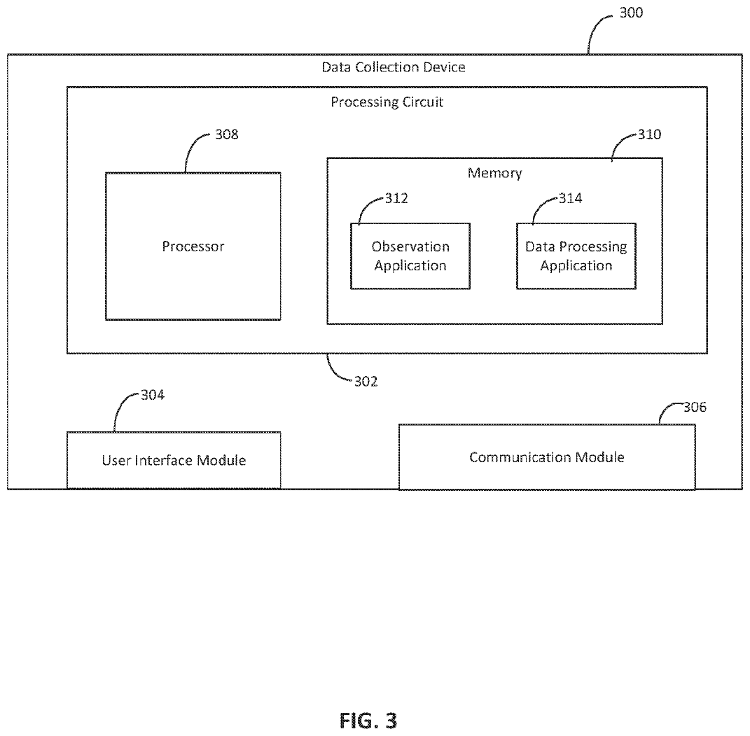

Turning now to FIG. 3, a block diagram of a data collection device 300 is shown, according to some embodiments. The data collection device 300 may be similar to the data collection devices of FIG. 1, such as the mobile device 106 and/or the dedicated communication device 108, and it is understood that the mobile device 106 and/or the dedicated communication device 108 may have similar structure to the data collection device 300 described below and can be used interchangeably herein. The data collection device 300 includes a processing circuit 302, a user interface module 304, and a communication module 306. The processing circuit 302 may include an electronic processor 308 and a memory 310. The processing circuit 202 may be communicably connected to one or more of the user interface modules 304 and the communication module 306. The electronic processor 308 may be implemented as a programmable microprocessor, an application specific integrated circuit (ASIC), one or more field programmable gate arrays (FPGA), a group of processing components, or other suitable electronic processing components.

The memory 310 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory 310 may include database components, object code components, script components, or other types of code and information for supporting the various activities and information structure described in the present application. According to one example, the memory 310 is communicably connected to the electronic processor 308 via the processing circuit 302 and may include computer code for executing (for example, by the processing circuit 302 and/or the electronic processor 308) one or more processes described herein.

In one embodiment, the memory 310 may include one or more applications, programs, etc., such as an observation application 312 and a data processing application 314. The observation application 312 may be a third-party application configured to interface with one or more internet services for collection, storage and/or processing of data received by the data collection device 300. For example, the observation application 312 may be configured to interface with internet services such as Facebook, Amazon, LinkedIn, or other third-party internet services. However, in some examples, the observation application 312 is a proprietary application for communication with one or more internet services, such as a proprietary internet service hosted on a device or system such as the central controller 110, described above. In some examples, the observation application 312 constantly communicates data from the data collection device 300 to an internet service as described above.

The data processing application 314 may be configured to process data received by the data collection device 300. For example, the data processing application 314 may process various data received from a sensor module, such as sensor modules 104a-c. In some examples, the data processing application 314 may be configured to package data received with one or more sensor modules 104a-c in preparation for transmitting the data to one or more other devices, such as the central controller 110. The data processing application 314 may further be configured to append metadata to the data received by the data collection device 300, such as time, date, location, etc. In some embodiments, the data processing application 314 may transmit the data to the observation application 312 for transmission to one or more internet services.

In some examples, the observation application 312 and/or the data processing application 314 may operate as background applications within the data collection device 300. For example, where the data collection device 300 is a mobile device, as described above, the observation application 312 and/or the data processing application 314 may operate in the background of the data collection device 300, thereby allowing the mobile device to operate as a data collection device 300 without requiring additional operation by a user of the mobile device, such as actively running an application, (e.g. the observation application 312 and/or the data processing application 314). This can allow for personal mobile devices to be used as data collection devices 300, thereby increasing the number of data collection devices 300 within an environment, without the expense or effort of integrating multiple dedicated data collection devices.

The user interface module 304 may allow for an operator to provide various inputs as well as receive outputs via the user interface. For example, the user interface module 304 may display one or more sensor devices in communication with the data collection device 300. Additionally, the user interface module 304 may display additional data associated with the one or more sensor devices, such as a network ID or address of the one or more sensor devices, received signal strength, sensor data, sensor power status (e.g., battery status), sensor type, and/or other information as required for a given application. The user interface module 304 may further include one or more inputs to allow for a user to instruct the data collection device 300 to perform one or more actions, such as scan for sensor devices, transmit data to other devices (e.g., a central controller), etc. In some examples, the user interface module 304 includes a touch-screen interface to allow for a user to both view outputs and provide inputs. The touch-screen interface may be one of a capacitive touchscreen, a resistive touchscreen, etc. In other embodiments, the user interface module 304 includes one or more devices or interfaces for receiving inputs and providing outputs, as required for a given application.

The communication module 306 may be configured to provide communications between the data collection device 300 and one or more external devices, such as one or more sensor devices and/or a central controller, such as central controller 110, described above. The communication module 306 may use one or more wireless communication protocols to provide communication to/from the external devices. In one embodiment, the local communication module uses Wi-Fi to provide communication to/from the sensor module 200. However, other wireless communication protocols, such as Bluetooth, Cellular (e.g., 3G, 4G, 5G, LTE, CDMA, TDMA, etc.), RF, Wi-Fi, LoRa, LoRaWAN, Z-wave, Thread, Matter, and/or any other applicable wireless communication protocol. As noted above, in some examples, the communication module 306 may use a proprietary communication protocol to facilitate communication to/from one or more external devices. In one embodiment, the communication module 306 is coupled to an antenna (not shown) for communicating to/from the data collection device 300. In some examples, the communication module 306 may be configured to use multiple communication protocols. For example, the communication module 306 may communicate with one or more sensor modules using a first communication protocol (e.g., Bluetooth, Wi-Fi, etc.) and then communicate with other devices, such as central controllers, using a second communication protocol (e.g., cellular, Wi-Fi, etc.).

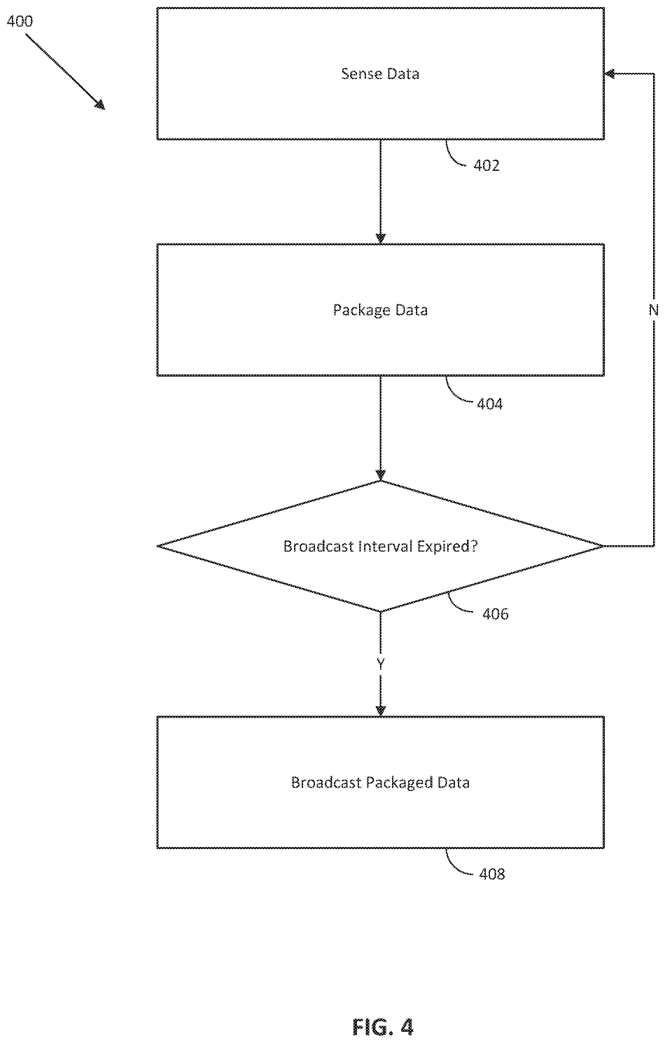

Turning now to FIG. 4, a flow chart illustrating a process 400 for collecting and broadcasting data from a sensor module, such as sensor module 200 described above, is shown, according to some embodiments. In one embodiment, the data packaging application 214 described above, is responsible for controlling the sensor module 200 to perform the process 400. At process block 402, the sensor module 200 senses one or more parameters of an associated electromechanical device, as described above. For example, the sensors 208 of the sensor module 200 may sense one or more parameters of an associated electromechanical device. As described above, sensed parameters may include various parameters, such as voltage, current, force, pressure, flow, motion, sound, and/or any other parameters associated with the electromechanical device as required for a given application. In some examples, the sensed parameters may include external factors related to the electromechanical device, such as temperature, moisture, gas presence, visual data, audio data, etc. Upon sensing the data, the sensor module 200 packages the data at process block 404. In one embodiment, the data packaging application 214 packages the data. In one embodiment, packaging the data may include converting the data into a broadcastable data packet. For example, in one embodiment, the sensed data may be integrated into a Wi-Fi SSID packet. In other embodiments, the data may be packaged for transmission over a communication protocol for communication to one or more data collection devices, such as data collection device 300, described above.

Upon packaging the data, the sensor module 200 determines whether a broadcast interval has expired at process block 406. In some examples, the broadcast interval may be approximately one second. However, values of more than one second or less than one second are also contemplated. In some examples, the broadcast interval may be set based on the type of data sensed by the sensor module 200. For example, a sensing module sensing flow within a pipe may have a faster broadcast interval than a sensor module 200 configured to sense levels (e.g., tank levels). In some examples, the broadcast interval may be shortened or overridden where the sensed data indicates a fault or critical error. In response to the broadcast interval being determined to not be expired, the sensor module 200 continues sensing data at process block 402. In response to determining that the broadcast interval has expired, the packaged data is broadcast at process block 408. In one example, the packaged data is broadcast via the communication module 206 using one or more communication protocols, as described above.

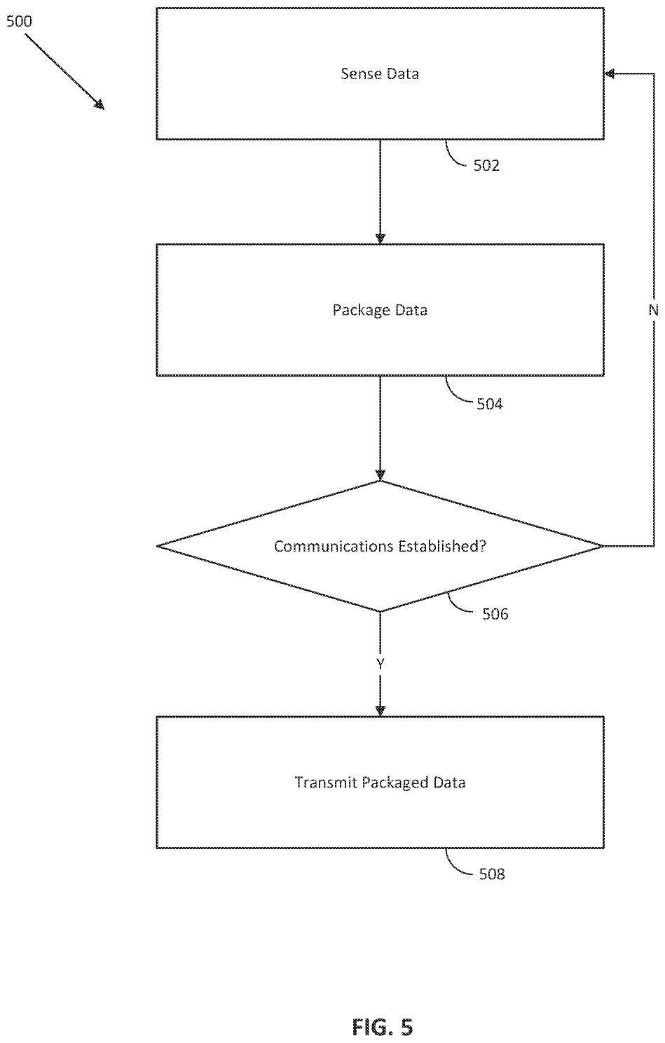

Turning now to FIG. 5, a flow chart illustrating a process 500 for collecting and transmitting data from a sensor module, such as sensor module 200 described above, is shown, according to some embodiments. In one embodiment, the data packaging application 214 described above is responsible for controlling the sensor module 200 to perform the process 500. In one embodiment, the data packaging application 214 described above, is responsible for controlling the sensor module 200 to perform the process 500. At process block 502, the sensor module 200 senses one or more parameters of an associated electromechanical device, as described above. For example, the sensors 208 may sense one or more parameters of an associated electromechanical device. As described above, sensed parameters may include various parameters, such as voltage, current, force, pressure, flow, etc. In some examples, the sensed parameters may include external factors related to the electromechanical device, such as temperature, moisture, gas presence, visual data, audio data, etc. Upon sensing the data, the sensor module 200 packages the data at process block 504. In one embodiment, the data packaging application 214 packages the data. In one embodiment, packaging the data may include converting the data into a transmittable data packet. For example, in one embodiment, the sensed data may be integrated into a Bluetooth data packet. In other embodiments, the data may be packaged for transmission over a communication protocol for communication to one or more data collection devices, such as data collection device 300, described above.

Upon packaging the data, the sensor module 200 determines whether communication has been established with an external device, such as a data collection device 300, at process block 506. For example, the sensor module 200 may be configured to establish communication with one or more external devices using one or more of the communication protocols described above. In some examples, the sensor module 200, such as via the communication module 206, broadcasts one or more messages or other data indicating that it can establish communication with an external device. For example, the sensor module 200 may broadcast Bluetooth message, Wi-Fi messages, Zigbee messages, or the like to establish communication with external devices within a communication range of the sensor device. For example, a sensor device may have a communication range of approximately 100 yards. However, distances or more than 100 yards and less than 100 yards are also contemplated. External devices may then receive the messages and establish a communication link (i.e., establish communications) with the sensor module based on the type of communication protocol. Thus, as an external device moves with respect to the various sensor modules 200 within a system, it can establish communication links with various sensor modules 200 as it moves into and out of communication ranges associated with the various sensor modules 200.

In response to determining that communication has not been established with an external device, the sensor module 200 continues to sense data at process block 502. In response to determining that communication has been established with an external device, the packaged data is transmitted at process block 508. In one example, the packaged data is transmitted via the communication module 206 using one or more communication protocols, as described above.

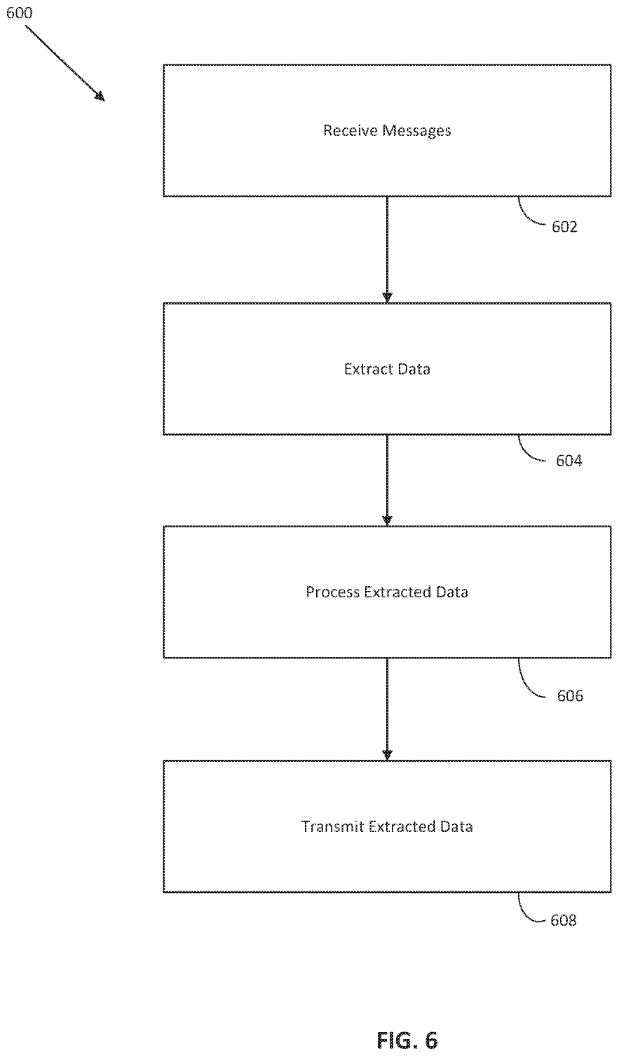

Turning now to FIG. 6, a flow chart illustrating a process 600 for receiving and processing data from one or more sensing modules is described, according to some embodiments. In some embodiments, a data collection device, such as data collection device 300, performs the process 600. At process block 602, the data collection device 300 receives messages from one or more sensor modules 200. As described above, the sensor modules 200 may broadcast data and/or transmit data over an established communication link to the data collection device 300. At process block 604, the data collection device extracts data from the one or more received messages. Upon extracting the data, the data is processed at process block 606. In some examples, the data processing application 314 processes the data. Processing the data may include validating the data, error checking the data, etc. Processing the data may further include determining whether one or more faults or other conditions have occurred based on the received data. For example, various faults (e.g., over-pressure, over-current, and/or other faults as determined for a required application) may be determined. In other examples, processing the data may include converting the data to a user consumable format and presenting the processed data to a user, such as via the user interface module 304.

Upon processing the data, the processed data is then transmitted at process block 608. In some examples, the data is transmitted to a central controller, such as central controller 110 for further processing. In other examples, the data may be transmitted to one or more internet services, such as via the observation application 312, as described above. In some examples, the data is transmitted via the communication module 306.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations and should in no way be construed to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A sensing device, comprising:
an input-output module configured to interface with an external device;
a communication module; and
one or more electronic processors, wherein the one or more electronic processors are configured to:
receive one or more parameters associated with the external device via the input-output module;
package the received data;
determine whether a broadcast interval has expired;
broadcast the packaged data in response to determining that the broadcast interval has expired.

2. The sensing device of claim 1, wherein packaging the data includes embedding the data into a Wi-Fi SSID packet.

3. The sensing device of claim 1, wherein broadcasting the data includes transmitting the data using one of a Wi-Fi protocol, and a Bluetooth protocol.

4. The sensing device of claim 1, wherein the external device is an electromechanical device.

5. The sensing device of claim 1, wherein the broadcast interval is one second.

6. A sensing device, comprising:
an input-output module configured to interface with an external device;
a communication module; and
one or more electronic processors, wherein the one or more electronic processors are configured to:
receive one or more parameters associated with the external device via the input-output module;
package the received data;
establish a communication link with one or more external devices; and
transmit the packaged data in response to establishing the communication link.

7. The sensing device of claim 6, wherein packaging the received data includes packaging the data into a Bluetooth message.

8. The sensing device of claim 6, wherein transmitting the packaged data includes transmitting the packaged data using one or more of a Wi-Fi protocol, a Bluetooth protocol, and a Zigbee protocol.

9. The sensing device of claim 6, wherein the external device is an electromechanical device.

10. The sensing device of claim 6, wherein the input-output interface is a general-purpose input-output interface.

11. The sensing device of claim 6, further comprising:
one or more sensors configured to sense supplemental parameters associated with the external device.

12. A method, comprising:
sensing one or more parameters of an electromechanical device;
packaging the sensed parameters into a message;
determining whether the message can be transmitted; and
transmitting the message to one or more external devices, based on determining that the message can be transmitted.

13. The method of claim 12, wherein the message is determined to be able to be transmitted based on determining that a broadcast interval time period has expired.

14. The method of claim 13, wherein the broadcast interval time period is one second.

15. The method of claim 12, wherein the message is determined to be able to be transmitted based on determining that a communication link with the one or more external devices has been established.

16. The method of claim 12, further comprising:
receiving the message at a first external device of the one or more external devices;
extracting data from the message; and
transmitting the extracted data to a central controller.

17. The method of claim 16, wherein the first external device is a smartphone.

18. The method of claim 12, wherein the message is transmitted using one or more of a Wi-Fi communication protocol and a Bluetooth communication protocol.

19. The method of claim 12, wherein packaging the data includes embedding the data into a Wi-Fi SSID packet.

20. The method of claim 12, further comprising receiving one or more parameters from the electromechanical device via an input-output interface of the electromechanical device, wherein the received parameters are separate from the sensed parameters.
